(19) United States
(12) Patent Application Publication
(10) Pub. No.: US 2010/0154844 A1
(43) Pub. Date: Jun. 24, 2010

(54) MODULE FOR WASHING TUNNEL

(76) Inventor: Claude Duterme, Troyes (FR)

Correspondence Address: DRINKER BIDDLE & REATH;ATTN: INTELLECTUAL PROPERTY GROUP, ONE LOGAN SQUARE, SUITE 2000, PHILADELPHIA, PA, 19103-6996, US

(21) Appl. No.: 12/663,973

(22) PCT Filed: Jun. 9, 2008
(86) PCT No.: PCT/FR08/51025

§ 371 Date: Jan. 21, 2010

(30) Foreign Application Priority Data
Jun. 15, 2007 (FR) 0755774

(51) Int. Cl. B08B 3/00

(52) U.S. Cl. 134/123

(57) ABSTRACT

A washing tunnel module has an arc-shaped structure defining a casing that includes water, pressurised air and washing/prewashing products supply, a control electric cabinet, a product pump, a foaming device and a foam distribution duct with spraying nozzles. The duct includes two symmetrical branches each associated with a module half. Each branch includes a duct having a large diameter downstream from the foaming device and is divided into a foam supply segment connecting the foaming device to the base of the mount of the arc inside the mount, a duct facing the module and extending from the base of the mount up to the crossbar. The duct is provided with spraying distribution nozzles.

### FIELD OF THE INVENTION

The present invention concerns a washing tunnel module comprising an arc-shaped structure forming a casing, housing the water supply, the prewashing/washing products supply, an electrical control cabinet, a product pump, a foaming device and a foam distribution duct equipped with spraying nozzles.

### PRIOR ART

Washing tunnels are already known which consist of arc-shaped modules following one after the other in the alignment of the washing tunnel on the path for vehicles so that each one performs a particular function, for example as is described in the document FR 04 52 036 (FR 2 875 198).

The washing functions are currently carried out by modules the use of which lacks flexibility and does not make it possible to obtain good quality foam and distribute it effectively for the cleaning and preparation of the bodywork of a vehicle.

In this type of tunnel, the functions of high pressure washing, high pressure washing with rollers and high pressure washing with polishing are separate functions.

By way of example, high pressure washing consists of a prewashing phase with spraying of polishing foam then passage through high pressure jets, followed by rinsing and drying. The function or programme of high pressure washing with rollers consists of carrying out prewashing, followed by a phase with high pressure jets, followed by passage beneath rollers with water and shampoo, optionally followed by passage beneath other rollers with spraying of water and shampoo, then rinsing and drying. In the case of the programme of high pressure washing with polishing, there is a prewash followed by high pressure spraying; then a polishing foam is distributed and dry rollers are then passed through. A second distribution of polishing foam is followed by a treatment with dry rollers. Finally, a polishing foam is applied with polishing rollers and then rinsing and drying are carried out.

These functions or programmes may comprise sub-programmes which consist in omitting or modifying certain phases. The different distributions of prewashing, washing or polishing products are carried out by modules through which the vehicle passes.

### AIM OF THE INVENTION

The aim of the present invention is to develop a washing tunnel module of the type defined above which effects the distribution of foam, or of liquid, during the passage of a vehicle in order to carry out its maintenance and cleaning effectively, with simple and effective means, permitting good preparation of the foam and effective production of the washing tunnel assembly.

### EXPLANATION AND ADVANTAGES OF THE INVENTION

To this end, the present invention concerns a washing tunnel module of the type defined above, characterized in that
the foam distribution bank is in the form of two symmetrical distribution branches, each associated with one half of the module, each of the branches comprising a large diameter duct starting from the foaming device at the base inside the pillar, and
a duct on the outside, on the façade of the module, leading from the base of the pillar onto the crossbeam forming the distribution branch equipped with foam distribution nozzles.

The module according to the invention makes it possible to obtain a particularly effective foam owing to the preparation of the water/product mixture upstream of the foaming device on the relatively long path between the water entry in the upper part of the module and the injection of the product at that point. Leaving the foaming device, the large cross-section segment of duct makes it possible to receive the foam without breaking it in order to distribute it under favourable conditions in the bank and via the sprayers onto the vehicle.

This excellent preparation of the foam not only permits efficient working but also a saving of product, favourable to the operating economy of the washing tunnel and reducing pollution.

According to another feature, the water is supplied via the top of the module in the region of the crossbeam and comprises, in the direction of entry of the water, a branching on the general duct with a stop valve and a non-return valve which are followed by a T-piece connected to the two branches, each branch having a solenoid valve followed by a flow regulating valve,

an entry branching for product downstream of the solenoid valve and upstream of the regulating valve,
an entry branching for compressed air downstream of the regulating valve and upstream of the foaming device.

The distribution of the water/product mixture between the two symmetrical parts of the module makes it possible to balance the flow rates satisfactorily and to produce the foam substantially close to the point where the foam is sprayed. In addition, and according to an advantageous feature, the duct connecting the foaming device to the connector inside the pillar of the module is a large diameter, transparent duct which makes it possible to monitor the state of the foam visually and to adjust this state (density) by acting on the air supply via the air regulating valve. In addition, the large diameter connector makes it possible to maintain the foam flow rate substantially constant so as not to form a constriction point capable of reducing the quality of the foam or to break the foam before the foam reaches the sprayers.

According to another advantageous feature, a product supply having a controlled pump, connected via a can of product and delivering the latter in a controlled manner through two respective ducts, each equipped with a non-return valve (AR-P) and with a regulating valve.

According to another advantageous feature, a compressed air supply starting from the general duct via a branching equipped with a stop valve and with a solenoid valve then with a T-piece connected to two respective ducts, each associated with one branch and each equipped with a non-return valve and a regulating valve in order to open out into the duct into which the water+product mixture passes.

The controlled supply of water and compressed air with the regulating valves and non-return valves allows completely safe operation, preventing water which may be charged with product from being pushed back into the general duct. In addition, it permits sequential operation of the different modules of the tunnel, without loss of product.

According to another advantageous feature, a chimney fixed transversely on the top of the module provides the connection with a distribution pathway installed above the washing tunnel for the passage of the water duct, the electrical supply cables, and the control cables, a branch conduit being provided each time to pass into the chimney and enter the module.

According to another advantageous feature, the duct forming the foam distribution branch at the façade of the module is made of transparent plastics material. It makes it possible to observe the passage of the foam so as to monitor its state at that point and, if necessary, to display the foam if the latter is coloured, in order to distinguish it according to the type of work to be carried out.

According to another advantageous feature, the module includes two foam distribution banks, installed in parallel and offset, at the façade, in order for each to distribute a foam having a different function, each bank being formed of two separate symmetrical branches.

The module equipped with two distribution banks increases the flexibility of operation of the washing tunnel and may be used for two functions alternately, in order to distribute two types of foam.

According to another advantageous feature, the module is formed of an assembly of stainless steel elements. This embodiment simplifies the manufacture, transport and installation of a module and consequently of a washing tunnel, and reduces maintenance.

According to another advantageous feature, the foam distribution nozzles are formed of a base support fixed to the duct and a removable nozzle body fixed to the base support.

This embodiment of the nozzles makes it possible on the one hand to simplify the installation and assembly and on the other hand to adapt each distribution bank to a certain type of foam and/or spraying, in order to modify the shape of the jet of foam, its orientation and its intensity.

### DRAWINGS

The present invention will be described in more detail below by means of an embodiment of an arc-shaped washing tunnel module, shown schematically in the appended drawings, in which:

FIG. 1 is a front view of a module,

FIG. 2 is a top view of the module of FIG. 1,

FIG. 3 is a diagram of the supply and control of the foaming devices of the two foam distribution branches,

FIG. 4 is a front view of an alternative embodiment of the module,

FIG. 5 is a top view of the module of FIG. 4,

FIG. 6 is a sectional view of a foam distribution branch and of a sprayer,

FIG. 7 shows in parts A and B a front view of a connector and a view in axial section thereof,

FIG. 8 shows in its parts A and B a front view and a sectional view of an alternative embodiment of the connector,

FIG. 9 shows the assembly of two connectors associated with two different foam distribution branches.

### DESCRIPTION OF AN EMBODIMENT

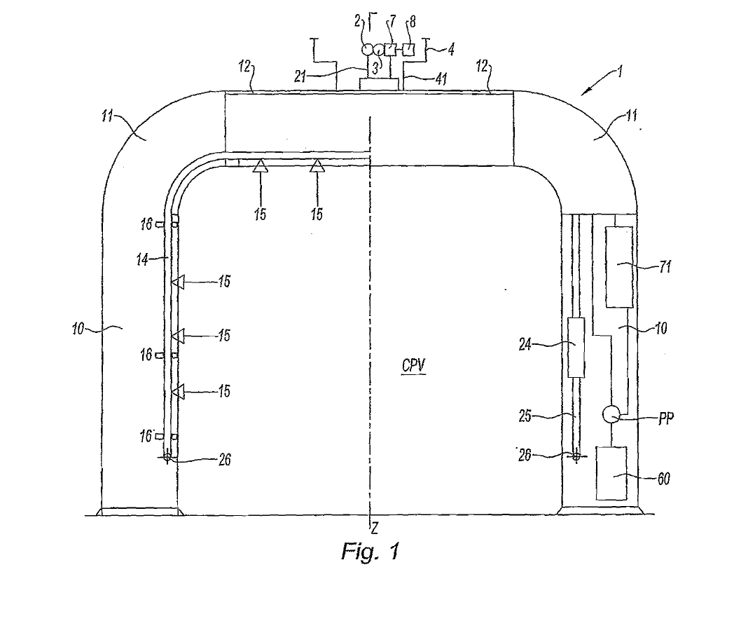

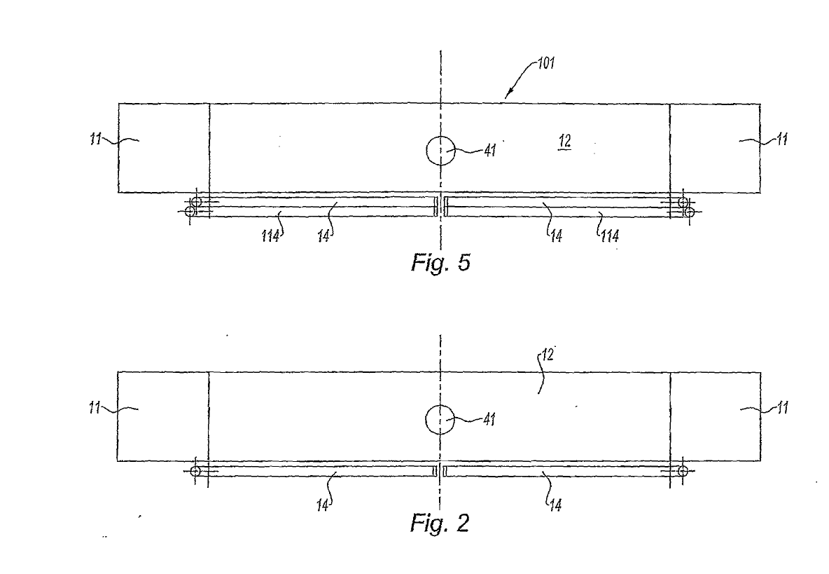

According to FIGS. 1 and 2, the invention concerns a washing tunnel module 1 having an arc-shaped structure straddling the path followed by the vehicles to be washed.

A plurality of modules are installed one after the other on the line on which the vehicles pass through the tunnel. The modules each perform a certain function and their equipment may vary from one module to another. The modules mainly perform three functions: high pressure washing, high pressure washing combined with washing with rollers and high pressure washing with polishing. The modules are adapted to each function by their equipment and the prewashing/washing/polishing products that they use. They are controlled by the control centre according to the programme requested by the client at the entry of the tunnel.

An example of a polyvalent module 1 will be described below in two variants.

By convention, the façade or front face of the module 1 is the face turned towards the front of the vehicle arriving in the tunnel.

The module 1, symmetrical with respect to the median plane ZZ, consists of two pillars 10 connected by elbows 11 to a crossbeam 12.

The module 1 is supplied with water, compressed air, and power and it receives the control signals, via ducts 2, 3 and cables 7, 8 installed in a distribution pathway 4 located above the line of passage of the vehicles CPV. The line of passage is perpendicular to the plane of FIG. 1.

The module 1 is equipped with a foam distribution bank 4 formed of two branches 14 which are symmetrical with respect to the plane ZZ. The branches 14 coming from the base of the pillars 10 follow substantially the contour of the arc, via an ascending rectilinear portion, then a portion in the shape of an arc of a circle, to join a horizontal portion on the crossbeam 12.

The branches 14 are equipped with foam spraying nozzles 15. The number of nozzles 15 and their distribution along the branch 14 depend on the function of the module 1, that is to say, on the product which it distributes and on the washing, cleaning or polishing to be carried out by the module or downstream thereof.

The nozzles 15 are directed in the plane of the drawing; they start laterally from the duct of each of the branches 14. Only half of this installation is shown in FIG. 1.

The top view of FIG. 2 shows the arrangement of the branches 14 with respect to the façade of the module 1.

Each branch 14 is a large cross-section foam distribution duct, made of transparent plastics material, preferably in one piece, and curved so as to permit the monitoring of the entry and distribution of the foam. In the case of a coloured foam, depending on the function of the foam or on the operation to be carried out, the colour allows additional monitoring.

The distribution duct forming each branch 14 is installed in collars 16, preferably also transparent, made of plastics material so that the assembly can be illuminated in order to emphasise the operation of the module.

FIG. 1 shows, on the left-hand side, the front face of the module 1 with the left-hand branch 14 of the foam distribution bank and the right-hand half of the module, as it appears when viewed from the rear, that is to say, opposite from the façade equipped with the distribution branch shown here.

In reality, the two halves of the module 1 are approximately symmetrical and each façade is equipped with a branch 14 of the foam distribution bank and the inside of each module half houses ducts and equipment such as described below. However, in the case of a distribution bank formed of two branches, for distributing a single product, there is only one can of product and one product metering pump on one side. The electrical cabinet is also only on one side.

The different circuits for supplying fluids and commands, the water supply (E), 2, the compressed air supply (A), 3 and the electrical current supply 7, as well as the bus-type control line 8 pass along the distribution pathway 4 located above the washing tunnel and independently of the latter. In the region of each module or gantry location, there are branchings permitting the operation of the module.

The module 1 has a chimney 41 connected to the distribution pathway 4 through which pass all the ducts and electrical cables of the module 1; similarly, the other modules of the tunnel are supplied from the distribution pathway, each via a chimney providing mechanical protection for the ducts and cables.

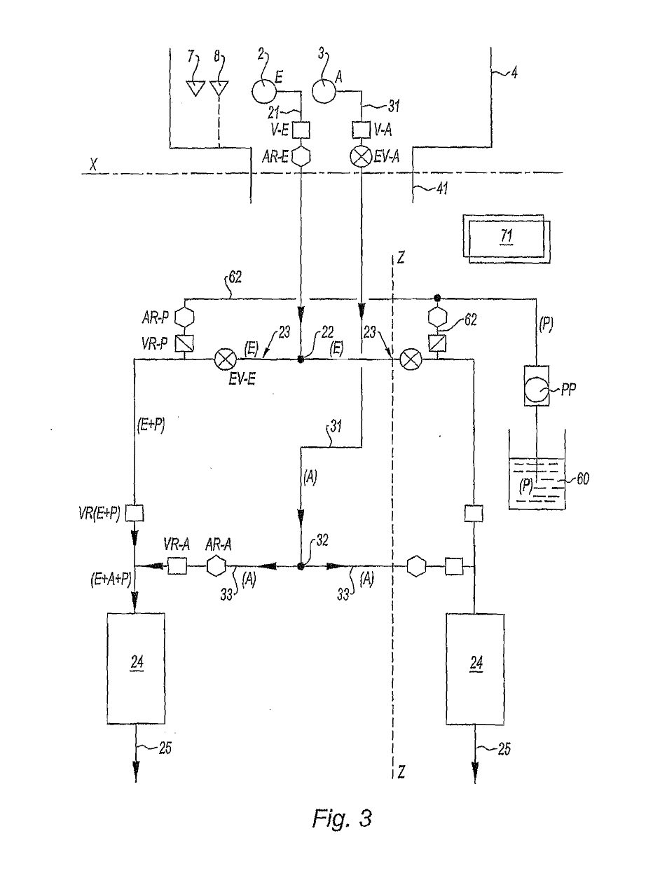

According to FIG. 3, in more detail, starting from the water distribution duct 2 in the distribution pathway 4, a branching 21 descends in the chimney 41 of the module. The branching 21 is equipped with a stop valve VE enabling the water supply (E) of the module 1 to be shut off for intervention over the entire downstream portion. This makes it possible, at the time of production of the tunnel, to provide for a certain number of branchings for all possible cases and then to adapt the tunnel, that is to say, the modules, to a particular embodiment. This also makes it possible to omit a module, if necessary, in order to simplify the tunnel while still keeping the branching in reserve.

Downstream of the stop valve VE, the water pipe 21 is equipped with a non-return valve AR-E, then a dividing T-piece 22 connected to the ducts 23 of the two branches 14, each supplying a foaming device 24 via a solenoid water valve EV-E and a regulating valve VR (E+P).

The compressed air duct (A) 3 has a branching 31 equipped with a valve V-A enabling the branching 31 to be shut off; this valve is followed by a solenoid valve EV-A for controlling the compressed air supply for the foaming devices 24 via the compressed air duct 31 equipped with a distribution T-piece 32 connected to two ducts 33, each associated with one branch of the installation. Each duct 33 equipped with a non-return valve AR-A and with a regulating valve VR-A, opens into the duct 23 for water charged with product, downstream of its regulating valve VR (E+P) and upstream of the foaming device 24. The distribution of the product P added to the water E takes place in the duct 23 downstream of the solenoid valve EV-E.

The product P is pumped by an electric metering pump PP into a can 60 of product (P) placed at the bottom of one of the pillars 10. The flow rate of the pump is controlled according to the operating parameters of the module.

The pump PP delivers the product P into a duct 61 dividing into two branches 62, 63, each equipped with a non-return valve AR-P and with a regulating valve VR-P before opening into the water duct 23 after the solenoid valve EV-E. Thus, the product (P) can thus mix well with the water (E) before the entry of air, upstream of the foaming device 24.

The solenoid valves EV-E, EV-A and the metering pump PP are controlled from the electrical cabinet 71 connected to the electrical supply line 7 and to the control line 8 passing through the distribution pathway 4. Branchings descend from the distribution pathway 4 into the chimney 41, then into the crossbeam 12, and the electrical cabinet 71. In order to simplify installation, even if the means are divided into two, that is to say, associated with each half of the installation, the metering pump PP and the electrical cabinet 71 are provided in only one of the two pillars 10 of the module 1.

The different modules of the installation are controlled by the control centre of the washing tunnel.

The items of equipment housed in the module are accessible through doors closing off the rear face of the pillars 10 and by a trap door in the region of the crossbeam 13.

The module 1 is preferably produced by the assembly of elements that are each formed by an upright pillar 10, its elbow 11 and the crossbeam 12 connecting the two elbows 11 of two pillars 10. The different elements are formed by walls fixed on three sides: the façade, the inner side and the outer side of the element, while the rear face is closed off by a door. The element forming the elbow 11 is closed on its four faces. Finally, the crossbeam 12 is open on the rear face, equipped with a flap-type access trap door and the top of the crossbeam carries the chimney joining the underneath of the distribution pathway. The elements 10, 11, 12 are preferably made of stainless steel sheet and are assembled on site by screwing.

The installation operates as follows:

In order to carry out a washing programme on their vehicle with the module (foam distribution), the control centre for the tunnel, having detected the arrival of the vehicle in the module by means of detectors that are not shown and, according to the washing programme selected by the driver of the vehicle, commands the starting up of the module 1 by opening the solenoid valves EV-E of the duct 21 to release the supply of water (E) and the solenoid valve EV-A of the air duct 31 to release the supply of compressed air (A).

The control also acts on the metering pump PP which draws product (P) from in the can 60 and injects it into the two ducts 23 downstream of the solenoid valves EV-E. The water/product mixture (E+P) then reaches the foaming device 24. The introduction of the product a long way upstream of the foaming device 24 makes it possible to homogenise the product/water mixture so that it is as even as possible when it reaches the foaming device 24.

The passage of the water charged with product and air into the foaming device 24 forms the foam; the foaming device contains a charge such as to integrate mechanically, by passage effect, liquid and air, and to form a foam. The foam emerges from the foaming device into the large dimension duct 25, in order to descend, pass through the connector 26 and rise up in the distribution branch 14 to be sprayed on the vehicle via the distribution nozzles 15. Without exception, distribution takes place symmetrically on both sides of the module 1.

The operation of the solenoid valves EV-E, EV-A and of the metering pump PP is managed from the central unit. At the end of the operation, the metering pump PP is stopped and then the solenoid valves EV-E, EV-A are closed and the distribution of foam ceases.

Upstream of the foaming device 24, the balancing valves VR(E+P) make it possible to balance the distribution of water and product (E+P) is between the two halves of the module 1 so that distribution is even, whatever the loss of head, which may be uneven, in the two branches 27.

The air regulating valve VR-A makes it possible to regulate the quantity of air introduced to form the foam, that is to say, the density of the foam.

Downstream of the foaming device 24, the large diameter duct 25 connected to the connector 26 at the base of the pillar, and transparent, allows the foam formed to be monitored by acting on the air regulating valve VR-A.

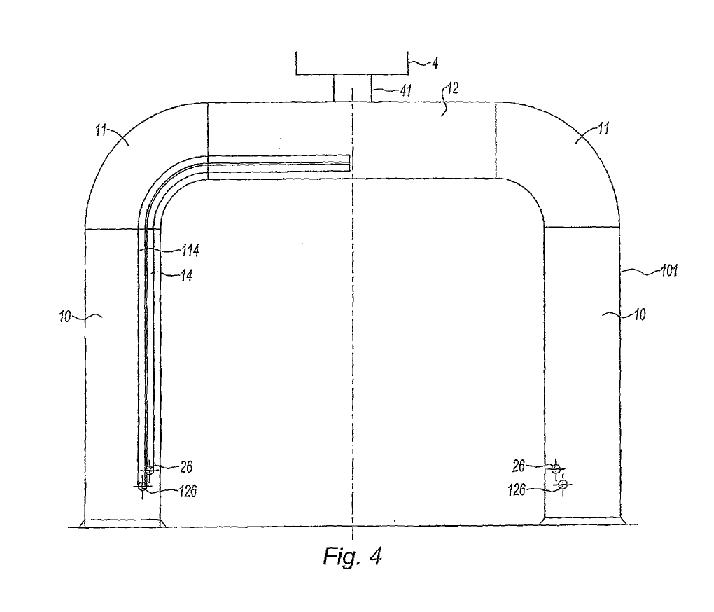

FIG. 4 shows a front view of a variant module 101 in which the façade is occupied by two foam distribution banks with two branches 14, 114 for each half of the module 101. The branches follow parallel paths and are preferably fixed in twin collars. The branches 27, 127 are offset with respect to each other as shown by the top view of FIG. 5, so that the nozzles, not shown, can spray their jet of foam in the direction of the vertical median plane of each set of two branches. The orientation and shape of the jets are adjustable according to the foam.

The internal equipment of the module 101 is not shown. It is in fact formed by equipment divided into two like that shown in FIG. 3. Each foam distribution branch 14, 114 has a foaming device associated with it, and the supply to each foaming device of the mixture of water, product and compressed air is independent, since the products are different.

FIG. 5 is a top view of the module 101 of FIG. 4, showing the offsetting of the banks 14, 114 on the two sides of the façade of the module.

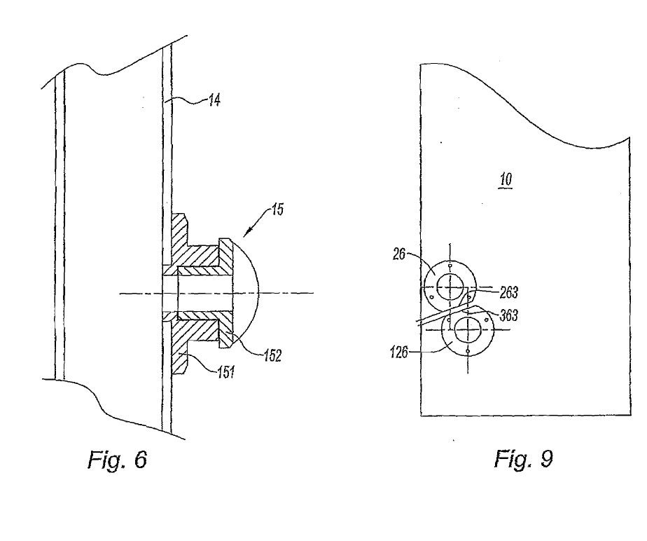

FIG. 6 is a view in axial section of the foam distribution duct of the branch 14 in the region of a spraying nozzle 15. The nozzle comprises a collar-type base support 151, fixed to the duct 14 around a bore, and it receives an end-piece 152, screwed into the support 151. The end-piece, which forms the actual sprayer, has a shape adapted to the shape of the jet to be produced. The end-piece 152 is also orientable with respect to the support 151 on the axis, so as to spread and direct the jet, in particular in a fan shape with the desired inclination.

Although in general the jet is fan-shaped in a vertical plane, other shapes of jet and directions are possible, according to whether the jet is directional, for example, jets intended to distribute the foam onto the wheel rims or the bottom of the body.

The support 151 is fixed to the duct 14 forming the foam distribution branch; the end-piece 152 is the removable element, for example is screwed or clipped into the support 151.

The passage channel formed by the spraying nozzle 15 has as continuous a shape as possible so as not to destroy the structure of the foam distributed by the duct 14.

In the case of the distribution of two foams as permitted by the module equipped like that in FIGS. 4 and 5, the means are divided into two: there are two product cans, each with a pump, and two mixing branches, downstream of the solenoid valves in order to control one or other branch and form the foam in a particular foaming device.

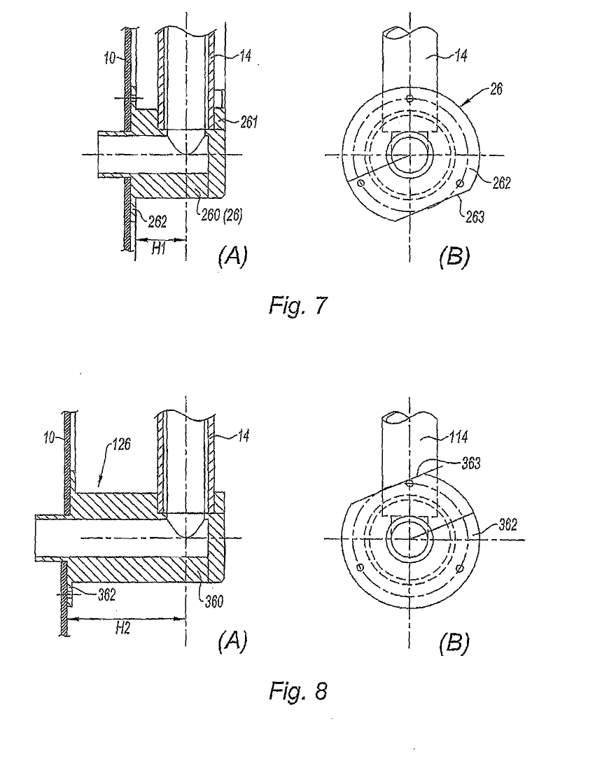

FIG. 7A shows a sectional view of a connector 26 installed in the façade of a pillar 10. The connector passes through the wall of the façade in order to be connected on the left-hand side inside the pillar, to the large diameter tube coming from the foaming device. This duct is not shown. The connector 26 which has its body 260 located outside the façade forms an elbow with a seat 261 in its upper part in order to receive the lower end of the foam distribution branch 14. The axis of the seat 261 receiving the duct of this connector is at a certain distance H1 with respect to the façade of the pillar 10.

FIG. 7B shows a front view of the connector 26 to which is connected the lower end of the foam distribution duct 14. The collar 262 of the body 160 has a truncated portion 263.

FIGS. 8A, 8B show a connector 126 similar to that (26) of FIGS. 7A-B but in which the distance H2 with respect to the façade of the pillar 10 is increased so as to be able to combine this connector 126 with the connector 26 of FIG. 7 and close to the latter, in an installation having branches 14, 114 divided into two as in the embodiment of FIGS. 4 and 5.

This makes it possible to bring the connectors 26, 126 closer together by their collars 262, 362 by their truncated portions 263, 363 as shown in the schematic view of FIG. 9 so as to reduce the overall dimensions not only of the connectors but equally of the installation inside the pillar and also that of the two branches at the façade (FIG. 3) and most of all to bring the ducts 27, 127 as close as possible to the passage of the vehicle in the module.

1. A washing tunnel module comprising an arc-shaped structure forming a casing which houses the supply of water, compressed air and prewashing/washing products, an electrical cabinet, a product pump, a foaming device and a foam distribution duct equipped with spraying nozzles,
characterized in that
the foam distribution bank is in the form of two symmetrical distribution branches, each associated with one half of the module, each of the branches comprising a large diameter duct starting from the foaming device at the base on the inside of the pillar, and
a duct on the outside, at the façade of the module, leading from the base of the pillar and onto the crossbeam forming the distribution branch equipped with foam distribution nozzles.

2. A module according to claim 1,
characterized in that
the supply of water takes place via the top of the module in the region of the crossbeam and comprises, in the direction of entry of the water, a branching on the general duct with a stop valve and a non-return valve which are followed by a T-piece connected to the two branches, each branch having a solenoid valve followed by a flow regulating valve,
an entry branching for product downstream of the solenoid valve and upstream of the regulating valve,
an entry branching for compressed air downstream of the regulating valve and upstream of the foaming device.

3. A module according to claim 2,
characterized by
a supply of product having a controlled pump, connected via a can of product and delivering the latter in a controlled manner via two respective ducts, each equipped with a non-return valve and with a regulating valve.

4. A module according to claim 2,
characterized by
a supply of compressed air starting from the general duct via a branching equipped with a stop valve and with a solenoid valve then with a T-piece connected to two respective ducts, each associated with one branch, and each equipped with a non-return valve and with a regulating valve in order to open out into the duct in which the water+product mixture passes.

5. A module according to claim 1,
characterized by
a chimney fixed to the crossbeam on the top of the module and connecting the top of the crossbeam to a distribution pathway installed above the washing tunnel for the passage of the ducts for water and compressed air, the electrical supply cables and the control cables, a branch conduit being provided each time in the region of the distribution pathway in order to pass into the chimney and enter the module.

6. A module according to claim 1,
characterized in that
it includes a large diameter connector fixed in the façade of the pillar in order to pass through the façade and receive on the inner side the large diameter duct leaving the foaming device and on the outer side the large diameter duct of the foam distribution branch.

7. A module according to claim 1,
characterized in that
the duct forming the foam distribution branch at the façade of the module is made of transparent plastics material.

8. A module according to claim 1,
characterized in that
the duct connecting the foaming device to the connector inside the pillar of the module is made of transparent plastics material.

9. A module according to claim 1,
characterized in that
it comprises two foam distribution banks installed in parallel and offset at the façade of the module, each for distributing a foam having a different function, each bank being formed of two separate symmetrical branches.

10. A module according to claim 1,
characterized in that
the module is formed of an assembly of elements made of stainless steel.

11. A module according to claim 1,
characterized in that
the foam distribution nozzles are formed of a base support fixed to the duct and of an end-piece screwed into the base support.

12. A module according to claim 2,
characterized by
a chimney fixed to the crossbeam on the top of the module and connecting the top of the crossbeam to a distribution pathway installed above the washing tunnel for the passage of the ducts for water and compressed air, the electrical supply cables and the control cables, a branch conduit being provided each time in the region of the distribution pathway in order to pass into the chimney and enter the module.
